(19) United States
(12) Patent Application Publication
(10) Pub. No.: US 2021/0015131 A1
(43) Pub. Date: Jan. 21, 2021

(54) PROCESS FOR THE PREPARATION OF THERMALLY INHIBITED STARCH AND/OR THERMALLY INHIBITED FLOUR

(71) Applicant: BENEO REMY, Wijgmaal (BE)

(72) Inventors: Joerg BERNARD, Obrigheim (DE); Bart LEVECKE, Sint-Katelijne-Waver (BE); Kristel DE VLEESCHOUWER, Buken (BE); Alireza HAJI BEGLI, Ramsen (DE)

(21) Appl. No.: 17/040,010

(22) PCT Filed: Mar. 20, 2019
(86) PCT No.: PCT/EP2019/056940

§ 371 Date: Sep. 21, 2020

(30) Foreign Application Priority Data
Mar. 21, 2018 (EP) 18163118.5

(51) Int. Cl. A23L 7/10; A23L 29/219; A23L 29/225; C08B 30/06

(52) U.S. Cl. CPC A23L 7/198; A23L 29/219; A23V 2002/00; C08B 30/06; A23L 29/225

(57) ABSTRACT

Disclosed is a process for the preparation of thermally inhibited starch and/or thermally inhibited flour having a moisture content lying between 5 and 30 wt. %, having the following steps:
a slurrying step, wherein thermally inhibited starch and/or thermally inhibited flour is combined with an aqueous phase to form a slurry; and
a drying step, wherein the aqueous phase of the slurry is separated off from the thermally inhibited starch and/or thermally inhibited flour,
   wherein in the slurrying step the pH of the slurry is brought to a value between 2.0 and 7.5.

The invention relates to a process for the preparation of thermally inhibited starch and/or thermally inhibited flour.

Such a process is known from U.S. Pat. No. 5,718,770. In this patent, known to be one of the base patents in the field of thermal inhibition of starches and flours, the preparation of a thermally inhibited starch is disclosed. Upon completion of the thermal inhibition, the thermally inhibited starch is subjected to a washing step (col. 2 line 64). A washing step as meant in U.S. Pat. No. 5,718,770 leads to the forming of a slurry; the slurry must then be dried, as starches and flours are usually provided to the market in powder form. Such drying is normally done to a moisture level lying between 5 and 30 wt. %.

It is a disadvantage of the known process that the washing/slurry formation and subsequent drying can lead to a partial loss of the properties that were conferred upon the starch or flour by thermal inhibition. One such property is the so-called shear stability, i.e. the ability of the thermally inhibited starch and/or thermally inhibited flour to provide a high viscosity in food products such as sauces where the preparation process entails exposure to high levels of shear.

It is the objective of the present invention to provide a process for the preparation of thermally inhibited starch and/or thermally inhibited flour wherein the partial loss of properties is reduced or even avoided.

The objective is achieved in that the process for the preparation of thermally inhibited starch and/or thermally inhibited flour having a moisture content lying between 5 and 30 wt. % comprises:
a slurrying step, wherein thermally inhibited starch and/or thermally inhibited flour is combined with an aqueous phase to form a slurry, such that the slurry has water as continuous phase and contains between 5 and 60 wt. %, preferably between 5 and 40 wt. %, expressed as percentage of dry matter on total weight of the slurry, of particles of thermally inhibited starch and/or thermally inhibited flour;
a drying step, wherein the aqueous phase of the slurry is separated off from the thermally inhibited starch and/or thermally inhibited flour to such an extent that thermally inhibited starch and/or thermally inhibited flour having a moisture content lying between 5 and 30 wt. % is formed,
   wherein in the slurrying step the pH of the slurry is brought to a value between 2.0 and 7.5.

It is an advantage of the process of the invention that an improved control over the properties of the thermally inhibited starch and/or thermally inhibited flour is achieved.

WO-A-2013/173161 discloses that an inhibited non-pregelatinized granular starch suitable for use as a food ingredient in substitution for a chemically modified starch may be prepared by heating non-pregelatinized granular starch in an alcoholic medium in the presence of a base and/or a salt. As noted on page 11 of WO-A-2013/173161, the inhibited starch may be washed with water and then re-dried. The pH of the slurry is not disclosed.

WO-A-2014/042537 discloses a process for producing thermally inhibited starch. The process comprises providing an alkaline starch having a pH between 9.1 and 11.2, adjusting the water content of the starch to between 2 and 22 wt. %, heating the starch between 130 and 190° C. for a sufficient time and at a sufficient pressure for the inhibition of the starch to be initiated before the water content has reached a level of 1 wt. % and before the pH has reached a value of 9, continuing heating the starch between 140 and 190° C. until viscostability is achieved, and cooling and optionally further processing the starch. As noted on page 6 of WO-A-2014/042537, the thermally inhibited starch may be washed, then dried. The pH of the slurry is not disclosed.

WO-A-96/22311 discloses that pregelatinized granular starches and flours are thermally inhibited by dehydrating a starch to anhydrous or substantially anhydrous and then heat treating the dehydrated starch at a temperature and for a time sufficient to inhibit the starch. The starch may be pregelatinized prior to or after the thermal inhibition using methods known in the art which retain the granular integrity.

As used herein, the terms ‘essentially’, ‘consist(ing) essentially of’, ‘essentially all’ and equivalents thereof have, unless noted otherwise, in relation to a composition or a process step the usual meaning that deviations in the composition or process step may occur, but only to such an extent that the essential characteristics and effects of the composition or process step are not materially affected by such deviations.

As used herein, the term ‘is brought to’ or equivalents thereof in relation to a parameter such as for example the pH or the moisture content of a system has the meaning that the parameter may be caused to increase, to decrease, or to remain unchanged—depending on the specific circumstances.

The preparation of thermally inhibited starch and/or of thermally inhibited flour is as such known, as illustrated by the documents cited above. Thermally inhibited starch and thermally inhibited flour have as an advantage that they are generally not regarded as chemically modified starch or chemically modified flour, do not need to be labelled with a European Union ‘E’ number or equivalent, and can thus be part of a ‘clean label’ approach to food product ingredients.

As is known, thermal inhibition of starch comprises a heat treatment at temperatures lying between 100 and 200° C. In a preferred embodiment the thermal inhibition is executed at an alkaline pH—i.e. at a pH above 7.0—whereby it is ensured that the starch has a moisture content below 1 wt. %. Consequently, upon completion of the thermal inhibition the moisture content of the thermally inhibited starch may be, and in a preferred embodiment is, below 1 wt. %.

As is known, thermal inhibition of flour comprises a heat treatment at temperatures lying between 100 and 200° C.

Upon having been initially prepared, thermally inhibited starch and thermally inhibited flour have a moisture content below their equilibrium value, typically significantly below their equilibrium value. As meant herein, the equilibrium moisture content is the value at 21° C. and 50% relative humidity. In the process of the invention the moisture content is brought, via steps that are discussed below, to a value lying between 5 and 30 wt. %. Preferably the moisture content is brought to at least 6, 7, 8, 9, 10, or even at least 11 or 12 wt. %; also preferably the moisture content is brought to at most 29, 28, 27, 26, 25, 24, 23, 22, 21, 20, 19, 18, 17, 16, or even to at most 15 or 14 wt. %. In an alternative preferred embodiment the moisture content is brought to within 5, 4, 3, 2, or even 1 wt. % of the equilibrium value of the thermally inhibited starch and/or of thermally inhibited flour.

According to the invention the desired moisture content of the thermally inhibited starch and/or thermally inhibited flour is achieved via a slurrying step, followed by a drying step.

In the slurrying step of the invention, the thermally inhibited starch and/or thermally inhibited flour is combined with an aqueous phase to form a slurry. The term slurry as meant herein has the usual meaning of a system having a liquid as continuous phase and containing solid particles, while still being able to flow and being transported in similar fashion as a liquid when being at a temperature between 5° C. and 60° C. The maximum weight percentage of solid particles that can be comprised in the slurry while still maintaining the characteristics of flowability and transportability will—as is known—depend on the precise nature of the particles. In the case of thermally inhibited starch or flour it is preferred that the solids content of the slurry lies between 5 and 60 or between 5 and 40 wt. %, more preferably between 10 and 35 wt. % or between 15 and 30 wt. %.

The thermally inhibited starch and/or thermally inhibited flour can be derived from a great number of sources, including but not limited to maize (corn), wheat, rice, potato, tapioca, sorghum, barley, rye, and any mixtures thereof. It was found that waxy variants of the starches and/or flours can provide beneficial properties. In one preferred embodiment the thermally inhibited starch and/or thermally inhibited flour are from rice, preferably waxy rice. In a further preferred embodiment the thermally inhibited starch and/or thermally inhibited flour are from maize, preferably waxy maize. In a yet further preferred embodiment the thermally inhibited starch and/or thermally inhibited flour are from wheat, preferably waxy wheat. In a yet further preferred embodiment the thermally inhibited starch and/or thermally inhibited flour are from potato, preferably waxy potato. In an even further preferred embodiment the thermally inhibited starch and/or thermally inhibited flour are from tapioca, preferably waxy tapioca.

The starch in the thermally inhibited starch and/or flour may be in native, granular form, i.e. the form in which the granules are not pregelatinized and show a Malteser cross under a microscope with polarized light, preferably when the starch grains have been stained with iodine. In a main preferred embodiment of the invention the thermally inhibited starch and/or thermally inhibited flour is essentially not pregelatinized; in this embodiment some pregelatinized starch or flour may be present only to such an extent that a slurry can still be formed. Even more preferably the thermally inhibited starch and/or thermally inhibited flour is not pregelatinized at all.

The thermally inhibited starch and/or thermally inhibited flour may constitute the entirety of the material entering the slurrying step, or it may be present in the form of a mixture with other compounds. In case of a mixture, the thermally inhibited starch and/or thermally inhibited flour is the largest dry matter constituent in the mixture, preferably representing at least 40, 50, 60, 70, 80, 90, or at least 95% of the mixture entering the slurrying step. Examples of possible other compounds in the mixture are: starches and flours that were not thermally inhibited, small quantities of pregelatinized starch or flour, other carbohydrates, proteins, and lipids.

Preferably the thermally inhibited starch and/or thermally inhibited flour has, when entering the slurrying step, a moisture content of at most 8 wt. %, preferably at most 6 or even at most 2 wt. %, more preferably at most 1.5 or 1.0 wt. %. In a particularly preferred embodiment of the invention it is ensured that the moisture content of the thermally inhibited starch and/or thermally inhibited flour does not exceed 8 or 6 or even 2 wt. %, more preferably does not exceed 1.5 or even 1.0 wt. % in the time frame between completion of the thermal inhibition and the execution of the process of the invention.

In a preferred embodiment the slurrying step is done within three months of preparation of the thermally inhibited starch and/or thermally inhibited flour. More preferably the slurrying step is done within two weeks, one week, one day, one hour, thirty minutes, or even immediately following preparation of the thermally inhibited starch and/or thermally inhibited flour.

The aqueous phase has water as its continuous phase and main constituent. Other compounds besides water may be present, and indeed will be in case of for example an industrial application of the invention where use is made of process water or other on-site available and suitable water streams. It is however preferred that the aqueous phase is essentially free, preferably free of other solvents such as ethanol. The aqueous phase preferably contains at least 80, 85, 90, or even at least 95, 96, 97, or 98 wt. % water. In an embodiment of the invention, the aqueous phase consists essentially of water, or even consists of water.

The temperature of the aqueous phase can vary within a wide range, and is preferably between 5 and 50° C., more preferably between 10 and 30° C. or even between 15 and 25° C.

According to the invention, the pH of the slurry is brought to a value between 2.0 and 7.5.

In one preferred embodiment, the required pH of the slurry is achieved by bringing the pH of the aqueous phase, prior to it entering the slurrying step, to a value such that the required value of the slurry is reached; in this embodiment, therefore, the pH of the thermally inhibited starch and/or thermally inhibited flour is taken into account. The desired pH value of the aqueous phase can be established via routine experimentation using a small sample of the thermally inhibited starch and/or thermally inhibited flour concerned. Thus, in case the thermally inhibited starch and/or thermally inhibited flour has a significant alkalinity it can prove to be necessary that the pH of the aqueous phase is brought to a value lower than 2.0.

In another preferred embodiment the required pH of the slurry is achieved by adjusting the pH of the slurry after it has been formed, preferably within one hour, more preferably within thirty or even within five minutes, most preferably immediately after it has been formed.

Adjustments of pH are as such well known to the person skilled in the art and can be achieved by for example the addition of a base such as sodium hydroxide or an acid such as sulphuric acid or by means of a buffer such as a citrate buffer.

As used herein, the pH of solid materials like thermally inhibited starch and/or thermally inhibited flour is determined at 21° C. and as follows: 10 g of test material to be measured is added to a beaker containing 100 ml of demineralised water, followed by stirring. The pH of the suspension is then measured by using a standard pH measuring device which has been calibrated. The pH as measured is deemed to be the pH of the test material.

The pH of the slurry according to the invention should be at least 2.0 in order to prevent that glycosidic bonds between the saccharide moieties of the starch are hydrolysed, a process which is known to occur at an accelerated pace at pH values below 2.0. More preferably the pH of the slurry is at least 2.5, 3.0, 3.5, or even at least 4.0.

The pH of the slurry according to the invention should be at most 7.5 as it was found that a beneficial effect on the properties of the slurry-dried thermally inhibited starch and/or thermally inhibited flour occurs when the pH of the slurry was below 7.5. More preferably the pH of the slurry is at most 7.3, 7.2, 7.1, 7.0, 6.9, 6.8, 6.7, 6.6, 6.5, 6.4, 6.3, 6.2, 6.1, or even at most 6.0.

As thermally inhibited starch and/or thermally inhibited flour are often alkaline in nature upon their initial preparation, this then requires that the aqueous phase preferably is acidic in nature, possibly even strongly acidic with values of for example between −1.0 and 6.0, in order to achieve the required pH value of the slurry of between 2.0 and 7.5. Preferably, the pH of the aqueous phase, before being combined with the thermally inhibited starch and/or thermally inhibited flour, is between 0.0 and 7.5 or between 1.0 and 7.0.

In general it is preferred that the pH of the aqueous phase, before being brought together with the thermally inhibited starch and/or thermally inhibited flour, is set by taking the pH of the thermally inhibited starch and/or thermally inhibited flour into account, such that the pH of the slurry can be between 2.0 and 7.5 or be within a preferred range between 2.0 and 7.5.

If it is not possible or not desired to set the pH of the aqueous phase before it is combined with the thermally inhibited starch and/or thermally inhibited flour so that the required pH of the slurry is achieved, then the pH of the slurry should upon its formation be brought to a value of between 2.0 and 7.5; preferably this pH adjustment is done within one hour, more preferably within thirty or even within five minutes, most preferably immediately or as soon as possible upon formation of the slurry. It is also possible to first adjust the pH of the aqueous phase and then adjust the value of the pH of the slurry as well; the adjustment of the pH of the slurry can then preferably be operated as a fine-tuning step.

The amount of aqueous phase which is combined with the thermally inhibited starch and/or thermally inhibited flour should be such that the resulting slurry has water as continuous phase; furthermore, the slurry should contain between 5 and 60 wt. % or between 5 and 40 wt. % of particles of thermally inhibited starch and/or thermally inhibited flour.

Once the slurry is formed, it is preferred that the slurry is subjected to a mixing action during at least a portion of the duration of the slurrying step. The mixing action—and indeed the slurrying step as a whole—can be executed by means that are as such known such as for example in a stirred vessel.

The duration of the slurrying step can vary between wide limits and is preferably between 10 seconds and 1 hour.

The temperature of the slurry during the slurrying step can vary between wide limits. If the thermally inhibited starch and/or thermally inhibited flour are and should remain in native/granular state, then it is preferred that the temperature of the slurry is brought to, and remains, at least 1° C. below the gel point of the thermally inhibited starch and/or thermally inhibited flour. Since the precise gel point of a starch in a slurry depends on various parameters, the gel point as meant herein is the temperature such that afterwards no significant gelatinisation, or even no gelatinisation at all can be observed—as evidenced by the presence of the well-known Maltese cross when seen under a microscope with polarized light, preferably when the starch grains have been stained with iodine. In a preferred embodiment it is ensured that the temperature of the slurry does not exceed 60° C.

If the temperature of the thermally inhibited starch and/or thermally inhibited flour is above its starting gel point, for example in case the slurrying step is executed immediately following the thermal inhibition, then the slurrying step should in a main embodiment of the invention be executed such that any gelatinisation and gel formation is kept to a minimum. This can be achieved by various means that are as such known, such as by bringing the temperature of the aqueous phase to an appropriately low level upon entry of the slurrying step or by implementing additional cooling means.

As mentioned above, it is an advantage of the invention that better control over the properties of the thermally inhibited starch and/or thermally inhibited flour can be obtained. It may be a further advantage of the invention that an improvement in colour- and odour aspects can be obtained. As is known, processes for thermal inhibition of starch or flour can lead to a discolouration, in particular to a darkening, of the starch or flour. Also, processes for thermal inhibition of starch or flour can lead to the formation of undesirable odours. It was found that the process of the invention may at least partially undo any undesirable discolouration or odour of the thermally inhibited starch and/or thermally inhibited flour.

Subsequent to the slurrying step, the drying step of the invention is done. In the drying step, at least a portion of the aqueous phase of the slurry is separated off from the thermally inhibited starch and/or thermally inhibited flour. This can be achieved via one or more operations that are as such known.

As meant herein, the meaning of the term drying step includes not only operations that primarily rely on dewatering via physical force/displacement, such as centrifuging or filter pressing, but also includes operations that primarily rely on evaporative dewatering, such as spray drying, flash drying, or oven drying. In a preferred embodiment of the invention the drying step consists of a combination of two or more operations, for example a combination of one or more operations primarily relying on dewatering via physical force/displacement and one or more operations primarily relying on evaporative dewatering.

The one or more operations in the drying step should be carried to such an extent that thermally inhibited starch and/or thermally inhibited flour having a moisture content lying between 5 and 30 wt. % is formed. Preferably the moisture content is brought to at least 6, 7, 8, 9, 10, or even at least 11 or 12 wt. %. Preferably the moisture content is brought to at most 29, 28, 27, 26, 25, 24, 23, 22, 21, 20, 19, 18, 17, 16, or even to at most 15 or 14 wt. %. In an alternative preferred embodiment of the invention the moisture content is brought to within 5, 4, 3, 2, or even 1 wt. % of the equilibrium value of the thermally inhibited starch and/or of the thermally inhibited flour; more preferably the moisture content is brought to a value between at most 3 wt. % below and at most 1 wt. % above the equilibrium value of the thermally inhibited starch and/or of the thermally inhibited flour.

In a main embodiment of the invention the drying step is executed such that essentially no gelatinisation takes place. Preferably the invention relates to a process for the preparation of thermally inhibited starch and/or thermally inhibited flour in granular form comprising the slurrying- and drying steps as outlined above. In this embodiment the thermally inhibited starch and/or thermally inhibited flour is in granular form when entering the slurrying step, remains in granular form throughout the process of the invention, and essentially no gelatinisation takes place in any step of the process.

Upon completion of the drying step, the thermally inhibited starch and/or thermally inhibited flour is typically recovered and processed further, for example by packaging the thermally inhibited starch and/or thermally inhibited flour.

The industrial implementation of the process of the invention can be in the form of a batch process, in the form of a continuous process, or in a mixed form thereof. In a main embodiment of the invention, the process is executed in means that are capable of processing between 1 and 1,000 tonnes per 24 hours.

In a main embodiment of the process of the invention, the thermally inhibited starch and/or thermally inhibited flour is a thermally inhibited maize starch. In this embodiment the thermally inhibited maize starch is in granular from as it enters the slurrying step and remains essentially in granular form throughout the process of the invention. Furthermore the moisture content of the thermally inhibited maize starch is at most 2 wt. % upon entry into the slurrying step, and had not exceeded this value since completion of the thermal inhibition. The slurrying step is done at a temperature of at most 60° C. and at a pH between 4.0 and 7.0, said pH value having been reached not later than at thirty minutes after formation of the slurry; the slurry contains between 10 and 35 wt. % of the thermally inhibited maize starch. In the drying step the moisture content of the thermally inhibited maize starch was brought to between 4 wt. % below and 2 wt. % above the equilibrium value.

In a further main embodiment of the process of the invention, the thermally inhibited starch and/or thermally inhibited flour is a thermally inhibited wheat starch. In this embodiment the thermally inhibited wheat starch is in granular from as it enters the slurrying step and remains essentially in granular form throughout the process of the invention. Furthermore the moisture content of the thermally inhibited wheat starch is at most 2 wt. % upon entry into the slurrying step, and had not exceeded this value since completion of the thermal inhibition. The slurrying step is done at a temperature of at most 60° C. and at a pH between 4.0 and 7.0, said pH value having been reached not later than at thirty minutes after formation of the slurry; the slurry contains between 10 and 35 wt. % of the thermally inhibited wheat starch. In the drying step the moisture content of the thermally inhibited wheat starch was brought to between 4 wt. % below and 2 wt. % above the equilibrium value.

In yet a further main embodiment of the process of the invention, the thermally inhibited starch and/or thermally inhibited flour is a thermally inhibited rice starch. In this embodiment the thermally inhibited rice starch is in granular from as it enters the slurrying step and remains essentially in granular form throughout the process of the invention. Furthermore the moisture content of the thermally inhibited rice starch is at most 2 wt. % upon entry into the slurrying step, and had not exceeded this value since completion of the thermal inhibition. The slurrying step is done at a temperature of at most 60° C. and at a pH between 4.0 and 7.0, said pH value having been reached not later than at thirty minutes after formation of the slurry; the slurry contains between 10 and 35 wt. % of the thermally inhibited rice starch. In the drying step the moisture content of the thermally inhibited rice starch was brought to between 4 wt. % below and 2 wt. % above the equilibrium value.

The invention will be illustrated with the following Examples and Comparative Experiments, without being limited thereto.

### COMPARATIVE EXPERIMENT A

A sample of a thermally inhibited waxy rice starch was used to form a slurry, using process water as circulating in the starch modification facility as aqueous phase. The process water had a pH of 7.5. The weight ratio between aqueous phase and thermally inhibited waxy rice starch was 70:30. The slurry had a pH of 7.7. The slurry was subsequently de-watered in a centrifuge during 15 minutes at 2,500 g, then dried to a moisture content of 11.3 wt. % to form a slurried-dried starch by means of oven-drying to 40° C.

Certain properties of the slurried-dried starch were determined by preparing a gel with the slurried-dried starch. The gel was prepared at 94° C. and 300 rpm in a Stephan UMSK 5 cooker equipped with a mixing insert having two rounded blades, using 135 g (dry matter) starch, citric acid and trisodium citrate to acidify and buffer to pH 3.6, and sufficient water to obtain a total weight of 2,500 g, whereby the citric acid and trisodium citrate were combined with the water before the starch was added. After cooling to 25° C., an intensive shearing action on the gel was done by means of a Silverson L4RT mixer using a square hole (2.4 mm) high shear screen mixer head at 5,000 rpm during 1 minute. The selection of rpm is done based a.o. on the nature of the gel; thus, in further examples hereinbelow it may be that another rpm is chosen in order to obtain the most meaningful insight into material behaviour. The rpm as used—always during one minute—will be reflected in the notation of viscosity parameter [symbol] by means of a subscript, whereby [symbol] ₃ indicates an rpm of 3,000, [symbol] ₅ indicates an rpm of 5,000, etc.

The viscosity and tan δ of a gel, made from the starch concerned, that had first been subjected to an intensive shear action, were determined at a temperature of 20° C. by means of an Anton Paar Rheometer (parallel plate-plate configuration; the plate diameter was 40 mm). As meant herein, the term tan δ is used in its common meaning of being a loss tangent in the linear viscoelastic region. It gives a ratio between viscous and elastic properties of a system, showing which one is the dominant one. With a tan δ value of 1, the elastic and viscous properties of the material are equal. The smaller the loss tangent is, the more elastic is the material.

The viscosity at 0.88 s⁻¹ was determined in a viscosity curve measurement wherein the shear rate varied from 0.1 to 100 s⁻¹.

The tan δ was determined from the results of an amplitude sweep measurement having the following characteristics: deformation from 0.01 to 1000%, frequency 1 Hz.

In the Examples and Comparative Experiments herein, the tan δ is always determined on a gel that has first been subjected to shear forces as described above, at the rpm as given per Example or Comparative Experiment.

The results were as follows:

| [symbol] | 1,870 mPa · s |
|---|---|
| pH | 8.60 |
| tan δ | Above 1 |
| [symbol] | 8,600 mPa · s |
| pH | 8.60 |
| tan δ | 0.42 |

### COMPARATIVE EXPERIMENT B

The properties of the thermally inhibited waxy rice starch as such, i.e. the raw material as used in Examples 1-3 without having been subjected to any subsequent process step such as slurrying, were measured. The properties were determined to be:

| [symbol] | 4,860 mPa · s |
|---|---|
| tan δ | 0.53 |

### EXAMPLE 1

A sample of the same thermally inhibited waxy rice starch as was used in Comparative Experiment A was used to form a slurry. An aqueous phase consisting of water which was brought to a pH of 6.8 using sulphuric acid was used. The weight ratio between aqueous phase and thermally inhibited waxy rice starch was 70:30. The slurry had a pH of 7.4. The slurry was subsequently de-watered in a centrifuge during 15 minutes at 2,500 g, then dried to a moisture content of 11.7 wt. % to form a slurried-dried starch by means of oven-drying to 40° C. The properties of the slurried-dried starch were determined to be:

| [symbol] | 2,770 mPa · s |
|---|---|
| pH | 8.07 |
| tan δ | 0.82 |
| [symbol] | 11,600 mPa · s |
| pH | 8.07 |
| tan δ | 0.35 |

### EXAMPLE 2

A sample of the same thermally inhibited waxy rice starch as was used in Comparative Experiment A was used to form a slurry. An aqueous phase consisting of water which was brought to a pH of 5.7 using sulphuric acid was used. The weight ratio between aqueous phase and thermally inhibited waxy rice starch was 70:30. The slurry had a pH of 6.8. The slurry was subsequently de-watered in a centrifuge during 15 minutes at 2,500 g, then dried to a moisture content of 12.6 wt. % to form a slurried-dried starch by means of oven-drying to 40° C. The properties of the slurried-dried starch were determined to be:

| [symbol] | 3,320 mPa · s |
|---|---|
| pH | 7.51 |
| tan δ | 0.73 |
| [symbol] | 13,100 mPa · s |
| pH | 7.51 |
| tan δ | 0.32 |

### EXAMPLE 3

A sample of the same thermally inhibited waxy rice starch as was used in Comparative Experiment A was used to form a slurry. An aqueous phase consisting of water which was brought to a pH of 3.7 using sulphuric acid was used. The weight ratio between aqueous phase and thermally inhibited waxy rice starch was 70:30. The slurry had a pH of 6.6. The slurry was subsequently de-watered in a centrifuge during 15 minutes at 2,500 g, then dried to a moisture content of 12.7 wt. % to form a slurried-dried starch by means of oven-drying to 40° C. The properties of the slurried-dried starch were determined to be:

| [symbol] | 4,020 mPa · s |
|---|---|
| pH | 7.14 |
| tan δ | 0.66 |
| [symbol] | 13,400 mPa · s |
| pH | 7.14 |
| tan δ | 0.28 |

As is evident from the results of the Comparative Experiments A and B, if slurry-drying not according to the invention is performed then a very significant loss of properties was established. This worsening in properties was evidenced by the much lower viscosity after shearing and by the lower elastic properties as seen in the higher tan δ in Comparative Experiment A vs. Comparative Experiment B (as is known, the smaller the loss tangent tan δ is, the more elastic is the material).

Examples 1-3 show that when slurry-drying according to the invention is executed, the worsening of properties due to slurry-drying is reduced significantly.

### COMPARATIVE EXPERIMENT C

A thermally inhibited waxy maize starch was, three months after its inhibition, used as raw material for a slurrying step. The pH of the aqueous phase was 7.7. The slurry contained 30 wt. % of the thermally inhibited waxy maize starch. The pH of the slurry was 7.6. The slurry was subsequently dried to a moisture content of 12 wt. % by means of filtration under vacuum and further drying in a rapid dryer (TG 200, Retsch) to form a slurried-dried starch. The properties of the slurried-dried starch were determined. The measurements were executed as described in Examples 1-3, with the exception of the rpm in the Silverson mixer. The mixer was set at 9,000 rpm. The results were:

| V₉ | 8,570 mPa · s |
|---|---|
| tan δ | 0.31 |

### COMPARATIVE EXPERIMENT D

The properties of the thermally inhibited waxy maize starch that was used in Comparative Experiment C as such, i.e. without having been subjected to remoistening or slurrying, were measured. The properties were determined to be:

| V₉ | 13,800 mPa · s |
|---|---|
| tan δ | 0.21 |

### EXAMPLE 4

A sample of the thermally inhibited waxy maize starch as used in Comparative Experiment C was used to form a slurry, however now using a different aqueous phase. The aqueous phase consisted essentially of water, was buffered (citrate buffer) and had a pH of 5.7. The pH of the slurry was 5.8. The slurry was subsequently dried to a moisture content of 12 wt. % by means of filtration under vacuum and further drying in a rapid dryer (TG 200, Retsch) to form a slurried-dried starch. The properties of the slurried-dried starch were determined to be:

| V₉ | 11,700 mPa · s |
|---|---|
| tan δ | 0.22 |

Example 4 shows that when slurry-drying according to the invention is executed, the worsening of properties due to slurry-drying (as evidenced in Comparative Experiment C) compared to the product as such (Comparative Experiment D) is reduced significantly.

### COMPARATIVE EXPERIMENT E

A thermally inhibited waxy wheat starch was, 14 days after its inhibition, used as raw material for a slurrying step. The pH of the aqueous phase was 7.7. The slurry contained 30 wt. % of the thermally inhibited waxy maize starch. The pH of the slurry was 7.6. The slurry was subsequently dried to a moisture content of 12 wt. % by means of filtration under vacuum and further drying in a rapid dryer (TG 200, Retsch) to form a slurried-dried starch. The properties of the slurried-dried starch were determined. The measurements were executed as described in Examples 1-3, with the exception of the rpm in the Silverson mixer. The mixer was set at 7,000 rpm. The results were:

| V₇ | 5,440 mPa · s |
|---|---|
| tan δ | 0.51 |

### COMPARATIVE EXPERIMENT F

The properties of the thermally inhibited waxy wheat starch that was used in Comparative Experiment E as such, i.e. without having been subjected to remoistening or slurrying, were measured. The properties were determined to be:

| V₇ | 10,000 mPa · s |
|---|---|
| tan δ | 0.34 |

### EXAMPLE 5

A sample of the same thermally inhibited waxy wheat starch as used in Comparative Experiment E was used to form a slurry, however now using a different aqueous phase. The aqueous phase consisted essentially of water, acidified with a citrate buffer to a pH of 5.7. The pH of the slurry was 5.8. The slurry was subsequently dried to a moisture content of 12 wt. % by means of filtration under vacuum and further drying in a rapid dryer (TG 200, Retsch) to form a slurried-dried starch. The properties of the slurried-dried starch were determined to be:

| V₇ | 10,400 mPa · s |
|---|---|
| tan δ | 0.31 |

Also Example 5 confirms that when slurry-drying according to the invention is executed, the worsening of properties due to slurry-drying (as evidenced in Comparative Experiment E) compared to the product as such (Comparative Experiment F) is reduced significantly.

### COMPARATIVE EXPERIMENT G

A thermally inhibited waxy rice starch was used, two months after the thermal inhibition was done, as raw material for a slurrying step. The pH of the aqueous phase was 7.8. The slurry contained 30 wt. % of the thermally inhibited waxy rice starch. The pH of the slurry was 8.0. The slurry was subsequently dried to a moisture content of 12.8 wt. % by means of means of filtration under vacuum and further oven-drying to 50° C. The properties of the slurried-dried starch were determined to be:

| [symbol] | 5,550 mPa · s |
|---|---|
| pH | 8.9 |
| tan δ | 0.44 |

### Comparative Experiment H

The properties of the thermally inhibited waxy rice starch that was used in Comparative Experiment G as such, i.e. without having been subjected to remoistening or slurrying, were measured. The properties were determined to be:

| V₅ | 10,450 mPa · s |
|---|---|
| tan δ | 0.31 |

### EXAMPLE 6

A sample of the same thermally inhibited waxy rice starch as used in Comparative Experiment G was used to form a slurry, however now using a different aqueous phase. The aqueous phase consisted essentially of water, acidified with a citrate buffer to a pH of 5.7. The pH of the slurry was 5.8 The slurry was subsequently dried to a moisture content of 13 wt. % by means of means of filtration under vacuum and further oven-drying to 50° C. to form a slurried-dried starch. The properties of the slurried-dried starch were determined to be:

| V₅ | 9,750 mPa · s |
|---|---|
| pH | 6.3 |
| tan δ | 0.34 |

### EXAMPLE 7

A slurry was prepared as in Comparative Experiment G. Five minutes after having been prepared, the pH of the slurry was reduced from 8.0 to 5.9 via the addition of sulphuric acid. After a further resting time of five minutes, during which the slurry was stirred slowly, the slurry was dried in the same way as in Comparative Experiment G. The properties of the slurried-dried starch were determined to be:

| V₅ | 9,840 mPa · s |
|---|---|
| pH | 6.9 |
| tan δ | 0.36 |

### EXAMPLE 8

Example 6 was repeated, with one difference: instead of adjusting the pH by means of a citrate buffer, the pH of the aqueous phase was adjusted by means of sulphuric acid prior to execution of the slurrying step. The properties of the slurried-dried starch were determined to be:

| V₅ | 10,100 mPa · s |
|---|---|
| pH | 6.3 |
| tan δ | 0.35 |

### COMPARATIVE EXPERIMENT I

A sample of a rice flour (Remyflo™ S200, supplier: Beneo-Remy) was brought to a pH of 9.3, then thermally inhibited and subsequently used to form a slurry, using process water as in Comparative Experiment A as aqueous phase. The process water had a pH of 7.8. The weight ratio between aqueous phase and thermally inhibited waxy rice starch was 70:30. The slurry had a pH of 7.6. The slurry was subsequently dried to a moisture content of 8.8 wt. % to form a slurried-dried starch by means of means of filtration under vacuum and further oven-drying to 50° C. The properties of the slurried-dried starch were determined to be:

| [symbol] | 21,300 mPa · s |
|---|---|
| pH | 8.2 |
| tan δ | 0.46 |

### COMPARATIVE EXPERIMENT J

The properties of the thermally inhibited rice flour as such, i.e. the raw material as used in Comparative Experiment I without having been subjected to any subsequent process step such as slurrying, were measured. The properties were determined to be:

| [symbol] | 28,100 mPa · s |
|---|---|
| pH | 7.6 |
| tan δ | 0.40 |

### EXAMPLE 9

A sample of the same thermally inhibited rice flour as used in Comparative Experiment I was used to form a slurry, however now using a different aqueous phase. The aqueous phase consisted essentially of water, acidified with sulphuric acid to a pH of 2.0. The pH of the slurry was 5.8. The slurry was subsequently dried to a moisture content of 11 wt. % by means of means of filtration under vacuum and further oven-drying to 50° C. to form a slurried-dried starch. The properties of the slurried-dried starch were determined to be:

| V₃ | 26,900 mPa · s |
|---|---|
| pH | 6.2 |
| tan δ | 0.40 |

1. A process for the preparation of thermally inhibited starch and/or thermally inhibited flour having a moisture content lying between 5 and 30 wt. %, comprising:
a slurrying step, wherein thermally inhibited starch and/or thermally inhibited flour is combined with an aqueous phase to form a slurry, such that the slurry has water as continuous phase and contains between 5 and 60 wt. %, expressed as percentage of dry matter on total weight of the slurry, of particles of thermally inhibited starch and/or thermally inhibited flour; and
a drying step, wherein the aqueous phase of the slurry is separated off from the thermally inhibited starch and/or thermally inhibited flour to such an extent that thermally inhibited starch and/or thermally inhibited flour having a moisture content lying between 5 and 30 wt. % is formed,
wherein in the slurrying step the pH of the slurry is brought to a value between 2.0 and 7.5.

2. The process according to claim 1, wherein in the slurrying step the slurry is formed such that the slurry has water as continuous phase and contains between 5 and 40 wt. %, expressed as percentage of dry matter on total weight of the slurry, of particles of thermally inhibited starch and/or thermally inhibited flour.

3. The process according to claim 1, wherein the thermally inhibited starch and/or thermally inhibited flour is not pregelatinized and has, when entering the slurrying step, a moisture content of at most 8 wt. % or at most 2 wt. %.

4. The process according to claim 1, wherein the slurrying step is done within three months of preparation of the thermally inhibited starch and/or thermally inhibited flour, or wherein the slurrying step is done immediately following preparation of the thermally inhibited starch and/or thermally inhibited flour.

5. The process according to claim 1, wherein during the slurrying step the temperature of the slurry is, and remains, at least 1° C. below the gel point of the thermally inhibited starch and/or thermally inhibited flour.

6. The process according to claim 1, wherein the drying step is executed such that essentially no gelatinisation takes place.

7. The process according to claim 1, wherein the drying step is executed in a centrifuge or in a filter press, in combination with at least one evaporative dewatering operation.

8. The process according to claim 1, wherein the drying step is executed such that the thermally inhibited starch and/or thermally inhibited flour has a moisture content lying between 10 wt. % and 15 wt. %.

9. The process according to claim 1, wherein in the slurrying step the pH of the aqueous phase, before being combined with the thermally inhibited starch and/or thermally inhibited flour, is or is brought to between −1.0 and 7.5 or between 1 and 7.

10. The process according to claim 9, wherein the pH of the aqueous phase is brought to a value between 2.0 and 6.0 or to a value between 2.5 and 5.0.

11. The process according to claim 1, wherein the pH of the slurry is brought to a value between 2.5 and 7.0 or to a value between 3.0 and 6.7.

12. The process according to claim 11, wherein the pH of the slurry is brought to a value between 3.5 and 6.4 or to a value between 4.0 and 6.0.

13. The process according to claim 1, wherein in the slurrying step the slurry is brought to the desired pH value within one hour of the formation of the slurry or within five minutes of the formation of the slurry.

14. The process according to claim 1, wherein the thermally inhibited starch and/or thermally inhibited flour is derived from rice, maize, wheat, potato, tapioca, or any mixtures thereof.

15. The process according to claim 1, wherein the thermally inhibited starch and/or thermally inhibited flour is chosen from the group consisting of: thermally inhibited rice starch, thermally inhibited waxy rice starch, thermally inhibited rice flour, thermally inhibited waxy rice flour, thermally inhibited maize starch, thermally inhibited waxy maize starch, thermally inhibited maize flour, thermally inhibited waxy maize flour, thermally inhibited wheat starch, thermally inhibited waxy wheat starch, thermally inhibited wheat flour, thermally inhibited waxy wheat flour, thermally inhibited potato starch, thermally inhibited waxy potato starch, thermally inhibited potato flour, thermally inhibited waxy potato flour, thermally inhibited tapioca starch, thermally inhibited waxy tapioca starch, thermally inhibited tapioca flour, thermally inhibited tapioca rice flour, and any mixtures of the aforementioned starches or flours.

16. The process according to claim 15, wherein the thermally inhibited starch and/or thermally inhibited flour is not pregelatinized and is chosen from the group consisting of: thermally inhibited rice starch, thermally inhibited waxy rice starch, thermally inhibited rice flour, thermally inhibited waxy rice flour, and any mixture thereof.

17. The process according to claim 15, wherein any thermally inhibited starch is obtained via a heat treatment at temperatures lying between 100 and 200° C. at an alkaline pH and at a moisture content below 1 wt. %.

18. The process according to claim 2, wherein the thermally inhibited starch and/or thermally inhibited flour is not pregelatinized and has, when entering the slurrying step, a moisture content of at most 8 wt. % or at most 2 wt. %.

19. The process according to claim 2, wherein the slurrying step is done within three months of preparation of the thermally inhibited starch and/or thermally inhibited flour, or wherein the slurrying step is done immediately following preparation of the thermally inhibited starch and/or thermally inhibited flour.

20. The process according to claim 16, wherein the slurrying step is done within three months of preparation of the thermally inhibited starch and/or thermally inhibited flour, or wherein the slurrying step is done immediately following preparation of the thermally inhibited starch and/or thermally inhibited flour.
